(19) United States
(12) Patent Application Publication
(10) Pub. No.: US 2022/0005197 A1
(43) Pub. Date: Jan. 6, 2022

(54) METHOD FOR THE AUTOMATED ANALYSIS OF CELLULAR CONTRACTIONS OF A SET OF BIOLOGICAL CELLS

(71) Applicants: UNIVERSITÉ CLAUDE BERNARD LYON 1, Villeurbanne (FR); CENTRE NATIONAL DE LA RECHERCHE SCIENTIFIQUE, Paris (FR); INSTITUT NATIONAL DE LA SANTE ET DE LA RECHERCHE MEDICALE, Paris (FR); ASSOCIATION FRANÇAISE CONTRE LES MYOPATHIES, Paris13 (FR)

(72) Inventors: Tessa Homan, Lyon (FR); Hélène Delanoe-Ayari, Lyon (FR); Adrien Moreau, Claret (FR); Alexandre Mejat, Bondoufle (FR)

(21) Appl. No.: 17/280,123

(22) PCT Filed: Sep. 25, 2019
(86) PCT No.: PCT/EP2019/075897

§ 371 Date: Mar. 25, 2021

(30) Foreign Application Priority Data
Sep. 26, 2018 (FR) 1858784

(51) Int. Cl. G06T 7/00; G06T 7/246

(52) U.S. Cl. CPC G06T 7/0016; G06T 7/246; G06T 2207/10056; G06T 2207/10016; G06T 2207/30024

(57) ABSTRACT

A method for analysis of cellular contractions of cells comprises recording a sequence of images of the cells. The sequence comprises a first image and a second image. The position of points of note in the first image are determined. The position of the same points of note in the second image, and for at least one point of note of the first image, is determined. A correspondence is established between the point of note of the first image and a point of note of the second image. The movement of the point of note, between the first image and the second image, is determined by comparing the position of the point of note of the first image and the position of the corresponding point of note of the second image.

### CROSS-REFERENCE TO RELATED APPLICATIONS

This application is a national phase entry under 35 U.S.C. § 371 of International Patent Application PCT/EP2019/075897, filed Sep. 25, 2019, designating the United States of America and published as International Patent Publication WO 2020/064855 A1 on Apr. 2, 2020, which claims the benefit under Article 8 of the Patent Cooperation Treaty to French Patent Application Serial No. 1858784, filed Sep. 26, 2018.

### TECHNICAL FIELD

The present disclosure relates to the field of analyzing the cellular contractions of a set of contractile biological cells, whether they are in vitro or in vivo.

### BACKGROUND

Analyzing the cellular contractions of a set of contractile biological cells, whether they are in vitro or in vivo, allows, for example, certain properties, for example physical or physiological, of biological cells to be deduced.

Although such an analysis may be performed by individuals manually, there is a need for automation, as this would allow, on the one hand, large volumes of data to be able to be processed, and, on the other hand, more objective and more robust results to be obtained.

### BRIEF SUMMARY

According to a first of its subjects, the disclosure relates to a method for automated analysis of the cellular contractions of a set of biological cells, comprising:
determining the position of a set of points of note (11) in the first image (10) of a temporal sequence of images of the set of biological cells, the sequence comprising a first image (10) and a set of at least one second image (20).

It is essentially characterized in that it further comprises steps of:
determining the position of the set of points of note (11) in the second image (20), and, for at least one point of note (11):
determining the movement of the point of note (11) between the first image (10) and the second image (20), by comparing the position of the first point of note (11) of the first image (10) and the position of the corresponding second point of note (11) of the second image (20).

Provision may furthermore be made for steps of:
defining a first region of interest (12) around the point of note (11) of the first image (10),
computing the intensity of the first region of interest (12) of the first image (10),
defining a second region of interest (22) in the second image (20), this region preferably being centered on a point in the second image (20) having the same coordinates as the point of note (11) of the first image (10), the second region of interest (22) being of the same shape and of the same size as the first region of interest (12), and
moving the second region of interest (22) to a set of positions in an arrival window (23) of the second image (20), and at each position:
   computing the intensity of the second region of interest (22), and
   computing a correlation between the intensity of the second region of interest (22) of the second image (20) and the intensity of the first region of interest (12) of the first image (10).

Provision may be made for the step of:
determining the movement of the point of note (11) between the first image (10) and the second image (20), to comprise preliminary steps of:
decreasing the resolution of the first image (10) and the resolution of the second image (20) according to an image pyramid; and
searching for the first region of interest (12) of the first image (10) in one of the images of the image pyramid.

Preferably, to achieve a higher robustness, the correlation computation is repeated sequentially on the pair of first and second images, using the same images at lower resolutions to start with.

Provision may be made for steps of, for each arrival window (23):
computing a correlation matrix corresponding to the set of positions of the second region of interest (22) in the window,
detecting the position of the correlation peak in the correlation matrix, and
assigning, as position of the point of note (11) in the second image (20), the position corresponding to the correlation peak.

Provision may be made for steps of:
displaying, on a display screen, at least one among the first image (10) and the second image (20), and
on at least one displayed image, graphically representing a vector between the point of note (11) of the first image (10) and the point of note (11) of the second image (20).

The vector graphically represents the movement of the point of note between the first and second images.

Provision may be made for steps of:
determining a cellular contraction wave of the set of biological cells by computing the movement of the point of note between the first image (10) and the set of at least one second image (20) as a function of time (t), and
computing at least one of the values among:
   the amplitude (A) of the cellular contraction wave of the set of biological cells,
   the speed of propagation of the cellular contraction wave of the set of biological cells,
   at least one propagation-speed gradient of the cellular contraction wave of the set of biological cells,
   the period (T) of the cellular contraction wave of the set of biological cells,
   the frequency (V) of the cellular contraction wave of the set of biological cells,
   the time interval between:
      the first image (10) and
      the first second image (20) of the sequence in which the movement of the point of note (11) between the first image (10) and the second image (20) is maximal, and
   the time interval between:
      the second image (20) in which the movement of the point of note (11) between the first image (10) and the second image (20) is maximal, and
      the first second image (20) of the sequence in which the movement of the point of note (11) between the first image (10) and the second image (20) is zero.

Provision may be made for a step of detecting during at least one period (T) of the cellular contraction wave whether the amplitude of the cellular contraction wave:
passes through a preset maximum number (E1, E3) the value of which is higher than a preset threshold value, or
passes through a preset minimum number (E2) the value of which is lower than a preset threshold value.

Provision may furthermore be made for a step of pharmacological screening.

Provision may furthermore be made for a prior step of employing phase-contrast microscopy to image the set of biological cells in order to obtain the temporal sequence of images.

According to another of its subjects, the disclosure relates to a computer program comprising program-code instructions for executing the steps of the method according to the disclosure, when the program is executed on a computer.

Other features and advantages of the present disclosure will appear more clearly on reading the following description, which is given by way of an illustrative and non-limiting example with reference to the accompanying figures.

### BRIEF DESCRIPTION OF THE DRAWINGS

FIG. 1A illustrates a first image comprising a point of note and a first region of interest according to the disclosure.

FIG. 1B illustrates a second image comprising the same point of note but moved and a second region of interest according to the disclosure, corresponding to the movement of the point of note after a contraction of the cells imaged in FIG. 1A, and the movement of the second region of interest in an arrival window.

FIG. 2A illustrates a contraction wave of healthy cells, computed according to the disclosure.

FIG. 2B illustrates a contraction wave of affected cells, computed according to the disclosure.

FIG. 3A illustrates the frequency of the cardiac contraction wave of the cells of three individuals.

FIG. 3B illustrates the average frequency of cardiac contraction of the cells of the three individuals of FIG. 3A, after a maturation phase.

FIG. 3C illustrates the amplitude of the cardiac contraction wave of the cells of the three individuals of FIG. 3A.

FIG. 3D illustrates the average amplitude of cardiac contraction of the cells of the three individuals of FIG. 3A, after a maturation phase.

### DETAILED DESCRIPTION

Proposed here is a solution that allows the cellular contractions of a set of contractile biological cells to be analyzed and which is based on digital processing of images of the set of cells.

For the sake of brevity, the terms “cells,” “biological cells,” and “contractile biological cells” have been used synonymously.

For example, the cells are induced pluripotent stem cells (IPS), which have the potential to differentiate into any cell in the human body, and in particular into the contractile cells or “cardiomyocytes” from which cardiac muscle is formed.

Cardiomyocytes differentiated from IPS are of particular interest because, as the heart is an organ that regenerates little, it is difficult to gain access to the cardiomyocytes of a patient. However, since heart diseases are often hereditary, genetic heritage is therefore important and the advantageousness of the present disclosure in this respect will be discussed below.

For the sake of brevity, only cardiomyocytes are described below. Of course, the invention is not limited to this type of cell and relates to any type of contractile biological cell: heart cells, muscle cells, etc.

Induced pluripotent stem cells derived from a sick patient or a healthy person and differentiated into cardiomyocytes exhibit a spontaneous, rhythmic contraction, which may be obtained in a few weeks, and have the particular advantage of preserving the genetic heritage of the patient. They may therefore advantageously be used to test new drugs and to study pathologies, including side effects, associated with these drugs.

However, induced pluripotent stem cells differentiated into cardiomyocytes are not only used to test drugs on diseased cells but may also be used to test the toxicity of substances to healthy cells.

Previously, it was almost impossible to work directly on human heart cells because taking heart samples is very complicated. Now, by virtue of pluripotent stem cells (obtained from easily taken samples of skin, blood or urine) it is easy to obtain healthy or diseased human cardiomyocytes.

Although techniques are already available for characterizing cardiomyocytes, such as for example electrophysiology techniques or atomic force microscopy (AFM), such techniques are expensive, often difficult to apply on large scales and to set up, and often require special consumables requiring the cells to be subcultured, which is not always possible or desirable.

A more complete, more flexible, simpler and less expensive solution is proposed here. It is easily accessible and allows the characterization of parameters of contractions of the cells.

Furthermore, embodiments of the present disclosure have the advantage of not requiring fluorescence.

Embodiments of the present disclosure are based on image processing. Provision is therefore made to record beforehand a temporal sequence of images of a set of cells. The image processing may be carried out in real time on a temporal sequence of images, or in deferred mode, on a temporal sequence of images recorded beforehand.

The sequence of images comprises a first image 10 (for example at time t=1) and a set of at least one second image 20, in the present case consecutive to the first image 10, i.e., a second image 20 (for example at time t=1+dt), a third image (for example at time t=1+2dt), a fourth image (for example at time t=1+3dt), etc., with dt a preset time interval.

For example, the sequence of images may be recorded in video form.

Provision may be made for the sequence of images to be obtained by virtue of a prior step of employing phase-contrast microscopy to image the set of biological cells, in particular in monolayer form.

For simplicity, the first image 10 is considered to be the first image 10 of the sequence and the second image 20 is considered to be the second image 20 of the sequence.

Provision is made to determine the position of a set of points of note in the first image 10. Since the cells are contractile, it is highly probable that the position of these points of note will vary from image to image. Provision is therefore made to determine the position of this set of points of note in the second image 20, as described in more detail below.

Preferably, provision is made to determine the position of the set of points of note in each image of the sequence.

For the sake of brevity, the term “second image” is understood to mean, irrespectively: the second image of the sequence, one of the images of the sequence, a plurality of images of the sequence or all the images of the sequence other than the first image 10.

Identification of a Point of Note 11 in the First Image:

Provision is made to identify a set of at least one point of note 11 in the first image 10. For the sake of brevity, the expressions “a set of at least one point of note 11” and “a point of note 11” have been used synonymously.

By “point of note,” what is meant is a pixel or a set of pairwise adjacent pixels that has a brightness or an intensity (where, by intensity what is meant is the luminous intensity measured by a sensor, i.e., the number of photons per unit time and area of the sensor) higher than a threshold value; or for which the contrast or intensity gradient, in a predefined direction and over a predefined distance, is higher than a predefined threshold value.

Typically, the points of note are the brightest points of the first image 10, i.e., local intensity maxima, or the points of the first image 10 that have the highest contrast. It is, for example, possible to use a LOCALMAX function of the software package MATLAB® or other equivalent functions of equivalent software packages applied to the first image 10.

Once the points of note have been identified, the coordinates of the points of note are known.

If the cell has undergone a contraction between the first image 10 and the second image 20, then at least one point of note 11 of the first image 10 has a different position in the second image 20, which it is necessary to determine as described below.

Once the position of a point of note 11 in the first image 10 and the position of the point of note 11 in the second image 20 are known, it is then possible to determine the movement of the point of note 11 between the first image 10 and the second image 20.

Specifically, by comparing the position (the coordinates) of the point of note 11 of the first image 10 and the position of the point of note 11 of the second image 20, the time interval between the first image and the second image 20 being known, it is possible to compute the movement of the point of note 11, i.e., at least one among:
the speed of movement of the point of note 11 between its position in the first image 10 and its position in the second image 20, and
the distance separating the position of the point of note 11 in the first image 10 and its position in the second image 20.

Identification of the Position of the Point of Note 11 in the Second Image:

The position of the point of note in the second image 20 is determined as follows.

First of all, provision is made to define a first region of interest 12 around the point of note 11 of the first image 10.

A region of interest is the set of pixels comprised in a sub-portion of an image and that has a preset shape, in the present case a rectangle the centroid of which is the point of note 11. The coordinates of the first region of interest are therefore known.

It is then possible to compute the intensity of the first region of interest 12 of the first image 10.

Next, similarly, provision is made to define a second region of interest 22, in the second image 20.

The second region of interest 22 (in the second image 20) has the same shape and the same size as the first region of interest 12 (in the first image 10), and preferably initially has the same position.

It is then a question of determining the position of the second region of interest 22 in the second image 20 such that the position corresponds to the movement of the point of note 11 between the first image 10 and the second image 20.

To this end, provision is made to move the second region of interest 22 to a set of preset positions in an arrival window 23 of the second image 20, the arrival window 23 itself having a preset shape, a preset size and a preset position.

At each position of the second region of interest 22 in the arrival window 23 of the second image 20, provision is made to compute the intensity (or grayscale value) of the second region of interest 22, and to compute a correlation between the intensity of the second region of interest 22 of the second image 20 for this position and the intensity of the first region of interest 12 of the first image 10.

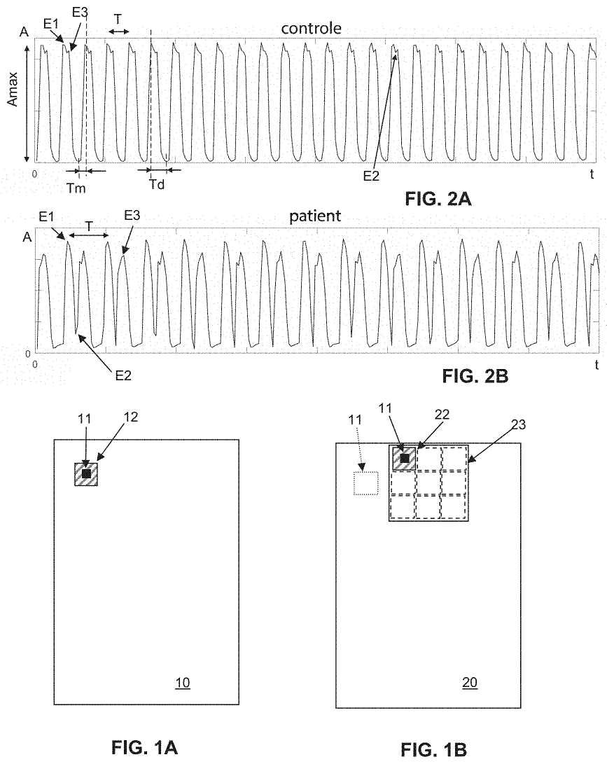

For example, in FIG. 1B the thin dotted lines show the position of the first region of interest 12 and the thick dashed lines show a set of preset positions of the second region of interest 22. In the present case, purely by way of illustration, nine adjacent positions have been shown for the second region of interest 22.

Each correlation value computed for a given position of the second region of interest 22 in the arrival window 23 is recorded as one coefficient of a correlation matrix, which comprises as many columns and rows as there are pixels of movement of the second region of interest 22.

It is then possible to detect, i.e., compute, the position of the correlation peak in the correlation matrix.

It is then possible to select the position of the second region of interest 22 that has the maximum correlation (correlation peak), i.e., the position for which the intensity of the second region of interest 22 is closest to the intensity of the first region of interest 12, in order to define, i.e., assign, the position of the point of note 11 of the second image 20, this ensuring the determination of the position of the point of note 11 in the second image 20.

Preferably, as many correlation matrices are computed as there are points of note, per image of the set of at least one second image 20. Purely by way of illustration, for a sequence of images of 101 images, i.e., a first image 10 and a set of 100 second images 20, and a set of 25 points of note per second image 20, thus 25*100=2500 correlation matrices are computed. Preferably, provision is therefore made to perform the correlation-matrix computations in parallel, in the present case on a graphics card.

The size of the arrival window 23 of the second image 20 may be proportional to the size of the region of interest of the first image 10.

For example, the size of the arrival window 23 of the second image 20 is equal to the size of the region of interest of the first image 10. For example, the second region of interest 22 is moved by one pixel for each position in the arrival window 23.

It is also possible to provide a step of estimating beforehand the average movement of the points of interest and of dimensioning the size of the arrival window 23 depending on the average movement of the points of interest.

If a point of note 11 moves to a position that is not comprised in one of the positions of the second region of interest 22 of the arrival window 23, then it will not be seen in the second image 20.

To limit this risk and to optimize the computations, provision may be made for a step of creating an image pyramid, which consists in obtaining multi-resolution representations of the first image 10 or of the second image 20, the resolution decreasing from that of the initial image to that of a very rough version thereof.

Thus, provision may be made to decrease the resolution of the second image 20 according to an image pyramid, in the present case a Gaussian pyramid, and to record the set of images obtained, each image having a corresponding resolution and a corresponding size.

It is then possible to search for the first region of interest 12 of the first image 10 in at least one of the images of the image pyramid, and to preferably do so, in a loop, in all the images of the pyramid, starting with the image of smallest size.

As the size of the images of the pyramid is smaller than the size of the original image, but the size of the region of interest remains the same, the ratio between the two differs in each image of the pyramid, this making it possible, on the one hand, to obtain a robust solution and, on the other hand, to be able to estimate the movement of the point of note 11 between the first image and the second image 20.

By virtue of the image pyramid, the movement is estimated at least roughly in the images of the pyramid of small size and more and more accurately in each image of larger size.

Typically, it is possible to use, for this purpose, a motion-tracking or point-tracking algorithm that is applied to each image of the image pyramid; in the present case, the KLT algorithm (KLT standing for Kanade-Lucas-Tomasi), which is notably known for its use in automatic control of on-board cameras, was used.

From a graphical point of view, provision may be made to display, on a display screen, at least one among the first image 10 and the second image 20 and, on at least one displayed image, provision may be made to graphically represent a vector between the point of note 11 of the first image 10 and the point of note 11 of the second image 20.

For example, provision may be made to draw a vector in the first image 10 or the second image 20 the origin of which is the position of the point of note 11 in the first image 10 and the end of which is the position of the point of note 11 in the second image 20, this allowing the movement of the point of note 11 between two successive images of the sequence to be illustrated graphically.

From image to image, it is possible to obtain movement field vectors, which contain spatial and temporal information on the movement of points of note, and therefore on the contraction.

It is possible to compute the norm of all of the vectors of an image and the strength of the vector field by averaging all the vectors.

The image processing thus carried out allows the movement of a point of note 11 between the first image 10 and the set of second images to be computed. The time separating the first image 10 from the set of second images in the sequence is known. The distance separating the position of the point of note 11 in the first image 10 and the position of the point of note 11 in the set of second images is computed, based on the pixel size, which is known.

Thus, it is possible to determine the variation in the movement of a point of note 11 as a function of time t, this variation as a function of time being a cellular contraction wave, as illustrated in FIG. 2A.

By averaging the movements of the set of points of note, it is possible to determine a cellular contraction wave of the set of biological cells.

Provision may be made to display a curve representative of the cellular contraction wave on a display screen.

Provision may be made for a step of interpolating the curve representative of the cellular contraction wave.

By virtue of the values of the curve, and where appropriate by Fourier transform, it is possible to make provision to compute at least one of the values among:
the amplitude A of the cellular contraction wave of the set of biological cells, and notably the maximum amplitude Amax, i.e., the maximum distance between the position of the point of note 11 of the first image 10 and the set of corresponding positions of the point of note 11 among the set of at least one second image 20,
the propagation speed of the cellular contraction wave of the set of biological cells, i.e., the speed of propagation of the point of note 11, which is a marker of the coupling between adjacent cells,
the gradients of the speed of propagation of the cellular contraction wave of the set of biological cells,
the period T of the cellular contraction wave of the set of biological cells,
the frequency 1/T of the cellular contraction wave of the set of biological cells,
the rise time Tm, i.e., the time interval between:
   the first image 10, and
   the first second image 20 of the sequence in which the distance between the point of note 11 of the second image 20 and the point of note 11 of the first image 10 is maximal, and
the fall time Td, i.e., the time interval between:
   the second image 20 in which the distance between the point of note 11 of the second image 20 and the point of note 11 of the first image 10 is maximal, and
   the first second image 20 of the sequence in which the distance between the point of note 11 of the second image 20 and the point of note 11 of the first image 10 is zero.

Thus, it is possible to determine the speed and duration of contraction, the speed and duration of relaxation, and the frequency and amplitude of contraction.

It is also possible to make provision to detect during at least one period of the cellular contraction wave whether the amplitude of the cellular contraction wave passes through:
at least two extrema the values of which are higher than a preset threshold value, or
comprises a number of extrema higher or lower than a preset threshold value.

As illustrated in FIG. 2B, the amplitude of the contraction wave passes through a first maximum E1, a minimum E2 and a second maximum E3. However, the value of the minimum E2 in FIG. 2B is much lower than the value of the minimum E2 in FIG. 2A, this being detectable via comparison with a threshold value.

It is thus possible to detect variations in the rhythm of the cellular contractions, and to detect aberrant contractile events.

It is thus possible to test the safety, efficacy or toxicity of a particular molecule on biological cells, and in particular human cells, prior to any test on an animal model. Provision may therefore be made for a step of pharmacological screening.

For example, the cellular contraction wave is recorded for a healthy individual (FIG. 2A), these cells are subjected to a particular molecule, and the cellular contraction wave is recorded in that context (FIG. 2B). It is thus possible to detect the physiological effects of the molecule in vitro, but also on cells having a desired genetic heritage directly.

The present disclosure is therefore particularly advantageous with respect to testing new molecules, new drugs, but also in a pharmacovigilance context, or even to studying associated pathologies, including side effects, as described below.

### Video Analysis

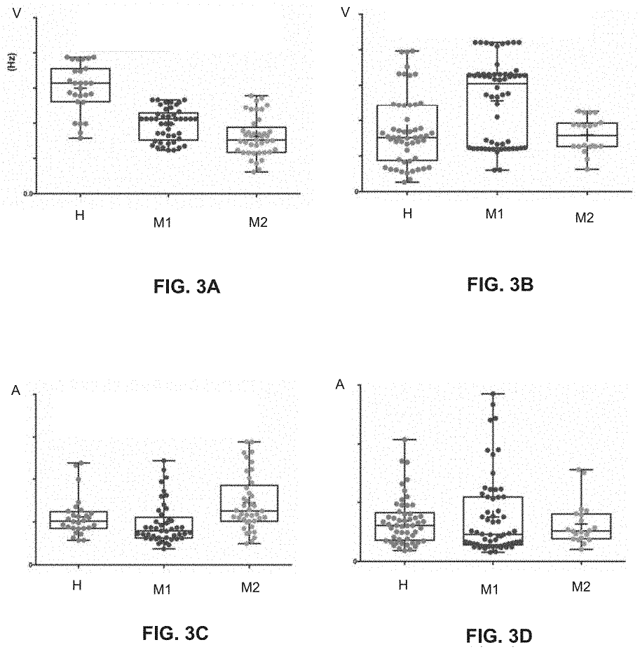

Each point in FIGS. 3A, 3B, 3C and 3D corresponds to the result or processing of the cells of an individual, corresponding, for example, to one of the curves illustrated in FIG. 2A or FIG. 2B.

In FIGS. 3A, 3B, 3C and 3D:
H is a healthy individual;
M1 is an individual exhibiting a first known abnormality, a genetic mutation, for example;
M2 is an individual exhibiting a second known abnormality, another genetic mutation, for example, or a second clone of M1.

FIG. 3A shows the frequency of the cardiac contraction wave of three individuals. Clearly the average frequency of individual H is higher than that of individual M1, which in turn is higher than that of individual M2.

FIG. 3B illustrates the response of the cells, i.e., the average frequency of contraction, of individuals H, M1 and M2 after a phase of cell maturation.

FIG. 3C represents the average amplitude of the cardiac contraction wave for the same three individuals.

FIG. 3D illustrates the response of the cells, i.e., the average amplitude of contraction, of individuals H, M1 and M2 after a phase of cell maturation.

It is clear that the effects of a given molecule on cell contraction may thus be measured. This not only makes it possible to directly test, for example, the effect of a molecule, in particular a therapeutic molecule, for example typically one intended to treat a disease of the heart, but also to test the side effects on human or animal cardiomyocytes of a therapeutic molecule typically intended to treat a disease of another organ, the liver for example.

Beyond the imaging of cellular contractions, embodiments of the disclosure may be implemented in fields other than biology, for example in chemistry or in physics, to study, by imaging, any, preferably periodic, wave, resonant or vibratory effect.

### NOMENCLATURE

E1: First maximum
E2: First minimum
E3: Second maximum
10 First image
11 Point of note
12 First region of interest
20 Second image
22 Second region of interest
23 Arrival window

1-10. (canceled)

11. A method for automated analysis of cellular contractions of a set of biological cells, the method comprising:
determining a position of a set of points of note in a first image of a temporal sequence of images of a set of biological cells, the temporal sequence comprising the first image and a set of at least one second image;
determining a position of a set of points of note in a second image, of the set of at least one second image; and
for at least one point of note, determining a movement of the at least one point of note between the first image and the second image, the determining comprising comparing a position of a first point of note of the first image and a position of a corresponding second point of note of the second image.

12. The method of claim 11, further comprising:
defining a first region of interest around the point of note of the first image;
computing an intensity of the first region of interest of the first image;
defining a second region of interest in the second image, the second region of interest being centered on a point in the second image having same coordinates as the point of note of the first image, the second region of interest being of a same shape and of a same size as the first region of interest; and
moving the second region of interest to a set of positions in an arrival window of the second image and, at each position:
computing an intensity of the second region of interest; and
computing a correlation between the intensity of the second region of interest of the second image and the intensity of the first region of interest of the first image.

13. The method of claim 12, wherein determining the movement of the at least one point of note between the first image and the second image further comprises:
decreasing a resolution of the first image and a resolution of the second image according to an image pyramid; and
searching for the first region of interest of the first image in one of images of the image pyramid.

14. The method of claim 12, further comprising, for each arrival window:
computing a correlation matrix corresponding to the set of positions of the second region of interest in the arrival window;
detecting a position of a correlation peak in the correlation matrix; and
assigning, as a position of the point of note in the second image, the position corresponding to the correlation peak.

15. The method of claim 11, further comprising:
displaying, on a display screen, at least one among the first image and the second image; and
on at least one displayed image, graphically representing a vector between the point of note of the first image and the point of note of the second image.

16. The method of claim 11, further comprising:
determining a cellular contraction wave of the set of biological cells, the determining comprising computing the movement of the point of note between the first image and the set of at least one second image as a function of time; and
computing at least one value among:
an amplitude of the cellular contraction wave of the set of biological cells,
a speed of propagation of the cellular contraction wave of the set of biological cells,
at least one propagation-speed gradient of the cellular contraction wave of the set of biological cells,
a period of the cellular contraction wave of the set of biological cells,
a frequency of the cellular contraction wave of the set of biological cells,
a time interval between:
the first image, and
a first second image, of the temporal sequence, in which the movement of the point of note between the first image and the second image is maximal, and
a time interval between:
the first second image in which the movement of the point of note between the first image and the second image is maximal, and
a first second image, of the temporal sequence, in which the movement of the point of note between the first image and the second image is zero.

17. The method of claim 16, further comprising:
detecting, during at least one period of the cellular contraction wave of the set of biological cells, whether the amplitude of the cellular contraction wave of the set of biological cells:
passes through a preset maximum number a value of which is higher than a preset threshold value, or
passes through a preset minimum number a value of which is lower than a preset threshold value.

18. The method of claim 11, further comprising pharmacological screening.

19. The method of claim 11, further comprising, prior to the determinations:
employing phase-contrast microscopy to image the set of biological cells to obtain the temporal sequence of images.

20. A computer program comprising program-code instructions for executing, on a computer, the method of claim 11.
